(19) United States
(12) Patent Application Publication
(10) Pub. No.: US 2007/0068731 A1
(43) Pub. Date: Mar. 29, 2007

(54) Energy absorber for personal fall arrestor

(75) Inventor: Richard R. Griffith, New Hartford, NY (US)

Correspondence Address: WALL MARJAMA & BILINSKI, 250 SOUTH CLINTON STREET, SUITE 300, SYRACUSE, NY, 13202, US

(73) Assignee: STURGES MANUFACTURING CO., INC., Utica, NY (US)

(21) Appl. No.: 11/439,015

(22) Filed: May 23, 2006

Related U.S. Application Data
(63) Continuation-in-part of application No. 11/237,157, filed on Sep. 28, 2005.

(51) Int. Cl. A62B 35/00

(52) U.S. Cl. 182/3

(57) ABSTRACT

An energy absorber for use in a personal fall arresting system. The absorber contains upper and lower webbings which are each two ply members. The back ply of the upper webbing is mounted adjacent to the face ply of the lower webbing with said webbing being of about equal length and width. Exterior tear elements run back and forth sinusoidally between attachment points on the face ply of the upper webbing and the back ply of the lower webbing. Interior tear elements run back and forth sinusoidally between attachment points on the back ply of the upper webbing and the top ply of the lower webbing. The attachment points are formed by transverse wefts of at least one of a polyester and a para-aramid yarn in which the tensile strength of the attachment points is greater than the tensile strength of the exterior and interior tear elements.

### CROSS REFERENCE TO RELATED APPLICATIONS

This application is a continuation-in-part (CIP) application of commonly owned and co-pending U.S. application Ser. No. 11/237,157, entitled: Energy Absorber for Personal Fall Arrestor, filed Sep. 28, 2005, the entire contents of which are incorporated by reference herein.

### FIELD OF THE INVENTION

This invention relates to an energy absorbing device suitable for use in a personal fall arresting system.

### BACKGROUND OF THE INVENTION

Workers who are obligated to work in high places such as on scaffolding, window ledges, and the like typically wear a body harness and/or a safety belt which is secured by a lanyard to some type of available anchorage. In the event the worker falls from a relatively high perch, he or she can reach a very high velocity in a matter of seconds. Depending upon the length of the lanyard, a falling worker's descent can be abruptly terminated causing serious bodily harm to the worker. Various shock absorbing devices have been developed over the years to decelerate a worker's fall, and thus cushion the resulting impact shock. The shock absorbing device or shock absorber is typically made part of the lanyard connecting the worker's body harness or belt to an anchorage. One prevalent type of shock absorber is disclosed in U.S. Pat. No. 3,444,957 to Ervin, Jr. that involves a length of high strength webbing that is folded over itself a number of times with the adjacent folds being stitched together. The stitching is adapted to tear apart when placed under a given dynamic load to absorb the energy generated by the fall. This type of absorber is relatively lightweight, compact, and thus easily portable as well as being easily retrofitted into existing safety systems. This type of shock absorber will herein be referred to as a tear-away type of energy absorber.

Various standards have been developed with regard to the above referred to devices. For example, the American National Standards Institute (ANSI) have created an American National Standard Z359 relating to personal fall arrest systems that was issued in 1992 and revised in 1999. Similarly, the Canadian Standards Association (CSA) issued a Canadian National Standard, Z259.11-05, relating to Energy Absorbers and Lanyards in 2005, superseding the previous edition published in 1992 and reaffirmed in 1998. Each of the above Standards addresses different safety system and methods for arresting the fall of a worker from a high place. These Standards are consistent with many of the standards in other countries, but the Canadian Standard is more stringent than most in that the requirement for dynamic drop testing must be performed upon test specimens that have been conditioned by heat and moisture. To that end, most tear-away energy absorbers that are tested cannot consistently pass the dynamic drop test set out in either the American Standard or the National Standard for Canada.

### SUMMARY OF THE INVENTION

It is therefore an object to improve personal fall arrest systems.

It is a further object to improve tear-away shock absorbers used in personal fall arrest systems.

It is still a further object to provide a web type tear-away shock absorber that can pass the dynamic drop and other performance tests set out in the American and Canadian National Standards covering safety requirements for personal fall arrest systems.

Another object of the present invention is to provide a tear-away shock absorber for use in a personal fall arrest system that is simple in design, lightweight, flexible, and easily integrated into existing systems.

These and other objects are attained by an energy absorber suitable for use in a personal fall arresting system that includes upper and lower two-ply webbings. Each webbing has a face ply and a back ply extending along the length of the webbing. The webbings are mounted one over the other with the back ply of the upper webbing being adjacent to and aligned with the face ply of the lower webbing. Exterior tear elements are arranged to run back and forth sinusoidally between attachment points located on the face ply of the upper webbing and the back ply of the lower webbing. Interior tear elements are arranged to run back and forth sinusoidally between attachment points located on the back ply of the upper webbing and the face ply of the lower webbing. Each of the attachment points are preferably formed by wefts of a polyester or a para-aramid yarn, such as for example, those manufactured under the trade names of Twaron or Kevlar.

In one version, the tear elements are coated with a material for reducing yarn on yarn abrasion especially after exposure to moisture which was seen to be effective over a range of temperatures from ultra cold to elevated. The tear elements are designed to tear away decelerating the worker's rate of fall and thus reduce the shock at impact, wherein the tensile strength of the interior and exterior tear element is less than that of the attachment points.

### BRIEF DESCRIPTION OF THE DRAWINGS

For a better understanding of these and other objects, reference will be made in the disclosure below to the accompanying drawings, wherein:

FIG. 1 is a partial perspective view illustrating a tear-away web type shock absorber that embodies the teachings of the present invention;

FIG. 2 is a perspective view of the shock absorber shown in FIG. 1, further illustrating the upper and lower webbings starting to separate under load;

FIG. 3 is an enlarged partial sectional view taken along lines 3-3 in FIG. 1 further showing the construction of the shock absorber;

FIG. 4 is a partial front elevation of a test stand for performing dynamic drop tests upon specimens of shock absorbers embodying the teachings of the present invention; and

FIGS. 5 and 6 are typical load versus time graphical plots for energy absorbers made in accordance with two different configurations, each of the configurations being tested based upon a different specified test standard.

### DETAILED DESCRIPTION

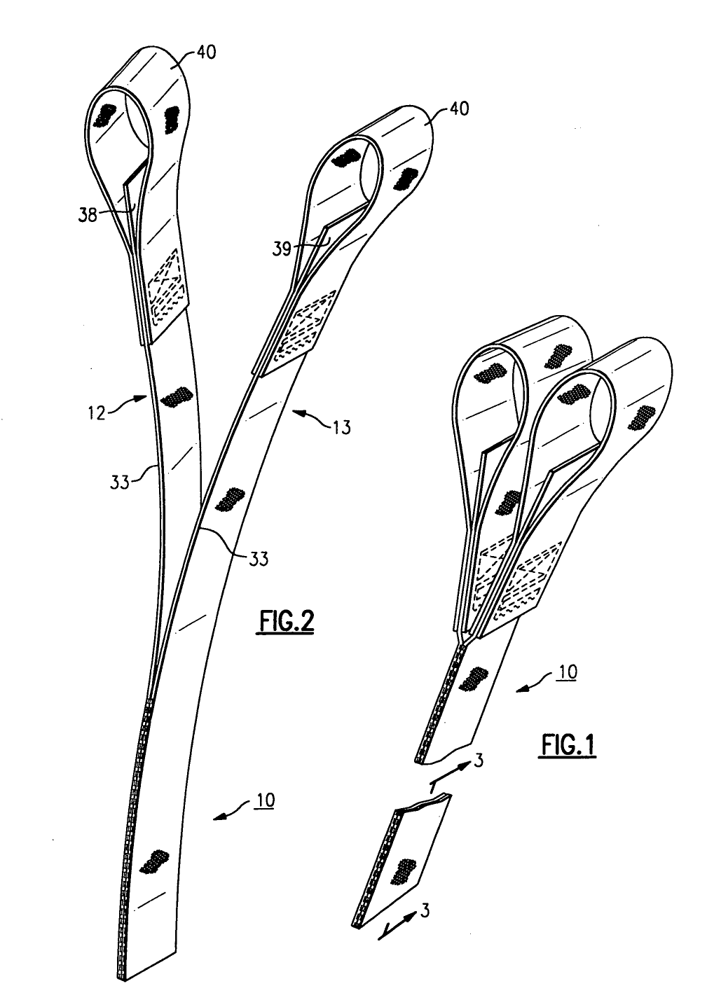

Turning now to FIGS. 1-3, there is illustrated a tear-away type energy absorber, generally referenced 10, that embodies the teachings of the present invention. The absorber 10 contains a pair of two-ply webbings that includes an upper webbing 12 and lower webbing 13. The two webbings 12, 13 are woven from high tenacity polyester yarns with each ply including a series of longitudinally extended ends having a series of warps 16 spaced along its length and filling yarn or wefts 17 consisting of a polyester or a para-aramid yarn that pass laterally throughout the warps to transverse the width of the yarn.

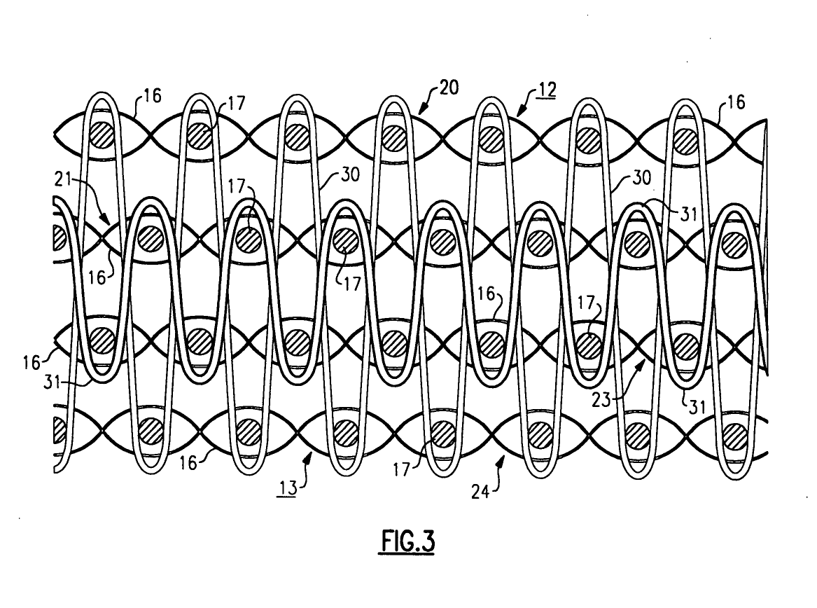

The upper webbing 12 contains a face ply 20 and a back ply 21. The lower webbing 13 similarly includes a face ply 23 and a back ply 24. The wefts 17 contained in the back ply 21, 24 of each webbing 12, 13 are arranged in assembly so that they are located about midway between the wefts 17 contained in the face ply 20, 23 of each webbing. The upper and lower webbings 12, 13 are of the same length and width. In assembly, the two webbings 12, 13 are superimposed in alignment one over the other with the back ply 21 of the upper webbing 12 being mounted adjacent to the face ply 23 of the lower webbing 13. As illustrated in FIG. 3, the wefts 17 in the two face plys 20, 23 are placed in commonly shared vertical rows and the wefts in the two back plys 21, 24 are also placed in commonly shared vertical rows with the rows containing the back ply wefts being located about midway with respect to the rows containing the face ply rows.

The two pieces of webbing 12, 13 are woven together using a series of binders that are formed by continuous strands of tear elements. The tear elements include what will herein be referred to as an exterior tear element 30 and an interior tear element 31. The tear elements 30, 31 in this embodiment are fabricated of high tenacity polyester yarns, although other suitable yarns, such as nylon or the like, having similar properties may be used without departing from the teachings of the present invention. The exterior tear element 30 runs back and forth in a sinusoidal manner between attachment points 17 on the face ply 20 of the upper webbing 12 and the back ply 24 of the lower webbing 13. The interior tear element 21 runs back and forth in a sinusoidal configuration between attachment points 17 on the back ply 21 of the upper webbing 12 and the face ply 23 of the lower webbing 13. As illustrated in FIG. 3, the laterally extended wefts 17 in each of the plys serve as the attachment points for both binders. The tensile strength of the two binders is less than that of the wefts 17 and as will be explained in greater detail below, the binders will tear out under load before the wefts 17 will rupture. A previously noted, the wefts 17 are made from a polyester or a para-aramid yarn. It has been found that para-aramid yarns such as those manufactured under the trade names of Kevlar by the E.I. Dupont de Nemours Company and Twaron by the Teijin Group are suitable for this purpose. It should be readily apparent, however, that other materials can be used, provided that the tensile strength of the wefts exceeds the tensile strength of the exterior and interior binders. A lock stitch 33 (FIG. 2) is included along the longitudinal knitted edge of each webbing 12, 13.

The two opposing ends 38 and 39 of the energy absorber 10 will typically be provided with connectors for attaching the energy absorber to a personal fall arrest system. In assembly, the energy absorber 10 will be placed in series with a lanyard for coupling the worker harness or safety belt to a suitable anchorage such as a stationary structural element having sufficient strength to arrest a worker's descent in the event of a fall. The lanyard provides sufficient length to permit the worker to move about with a reasonable amount of freedom. In the event of a fall, the lanyard will play out until it becomes taut at which time the dynamic load of the falling worker is taken up by the energy absorber whereupon the binders begin to tear away absorbing the kinetic energy generated by the fall. The rate of the fall is thus decelerated, lowering the force acting upon the worker's body as the fall is being arrested.

Applicant, in order to insure that it is in compliance with the National Standards of Canada and the United States, has constructed a test stand for dynamically testing sample absorber specimens of the type described above. As illustrated in FIGS. 1 and 2, the test specimens were equipped at each end with high strength non-elastic loop connectors 40 and 41 that are sewn into the ends of the absorber. The connectors 40, 41 will not pull out or elongate when experiencing dynamic load well in excess of one thousand pounds.

With further reference to FIG. 4, the test stand contains an anchorage consisting of a horizontal cross beam 50 supported upon a pair of spaced apart vertical columns, one of which is depicted at 51. Although not shown, the cross beam 50 is suspended above a drop pit containing a deep layer of sand. During a test, the two loop connectors 40, 41 of the energy absorber 10 are initially provided with shackles and the shackle of one loop connector is connected to an anchorage point. A ten pound weight is suspended from the other loop connector and the distance between the two loop fold over points recorded. A load cell 53 is securely mounted upon the center of the cross beam 50 and one of the energy absorber loop connectors 41 is attached to the load cell 53 by a suitable eyebolt (not shown).

For purposes of the following discussion, two configurations are discussed, each relating to aspects of the Canadian Z259 Standard; namely, an E4 compatible configuration or version and an E6 compatible configuration or version. Other suitable configurations or versions will be readily apparent to this discussion as those described are intended to be exemplary. An air activated release mechanism 55 is connected to a weight 52 by means of a suitable shackle. For purposes of the E4 standard, the weight 52 is 100 kilogram and 160 kilogram for an E6 compatible design. The weight 52 is connected to a hoist 60 which is used to raise the weight to a desired height. A 2,440 millimeter long wire rope lanyard equipped at each end with thimble eyes or equivalent structure in order to attach the weight 52 to the other loop of the energy absorber using a shackle. The distance between the shackles when the lanyard is placed under a 44 N load is measured and recorded prior to attaching the test lanyard between the weight 52 and the energy absorber 10. The test weight 52 is hoisted to a height such that the weight can free fall a distance of 1.8 meters before the test lanyard becomes taut and the energy absorber becomes active.

At this time, the quick disconnect mechanism is released and the weight 52 is allowed to drop, thereby activating the energy absorber 10, whereupon the tear elements break away, decelerating the falling weight and bringing the weight to a controlled halt. The distance between the foldover points of the two loops upon the played out energy absorber is then measured and the permanent elongation of the absorber 10 is calculated by subtracting the initially recorded foldover distance prior to the absorber being activated and the final foldover distance measurement. The elongation tear length of the energy absorber is recorded and the peak load and average load data are graphically provided by the readout of the load cell 53.

In order to meet the requirements of the above referred to Canadian Standard and the American National Standard, test specimens of a given energy absorber design must pass a number of dynamic drop tests that are carried out under different conditions. For the Canadian National Standard, these drop tests include the following:

1) Ambient testing of specimens at 20° C., ±2° C., wherein the arresting force for the E4 compatible version does not exceed 4.0 kN and the permanent elongation of this same energy absorber shall not exceed 1.2 meters. For the E6 compatible version, the maximum arresting force does not exceed 6.0 kN and the permanent elongation does not exceed 1.75 meters;

2) Elevated temperature testing of a specimen that has been conditioned at 45° C., ±2° C., for a minimum of eight hours. The test is carried out within five minutes after conditioning is completed wherein the arresting force for the E4 compatible version shall not exceed 6.0 kN and the permanent elongation for this same energy absorber shall not exceed 1.2 meters. For the E6 compatible version, the maximum arresting force does not exceed 8.0 kN and the permanent elongation does not exceed 1.75 meters;

3) Wet testing of a specimen that has been immersed in water at 20° C., ±2° C., for a minimum of eight hours. Under this test, the specimen of the E4 compatible version shall not exceed an arresting force of 5.0 kN and the permanent elongation for this energy absorber shall not exceed 1.2 meters. For the E6 compatible version, the maximum arresting force does not exceed 7.0 kN and the permanent elongation does not exceed 1.75 meters;

4) Cold testing of a specimen is also carried out wherein the specimen is conditioned at a temperature of −35° C., ±2° C., for eight hours and tested within five minutes upon completion of the conditioning. The E4 compatible version energy absorber shall limit the maximum arresting force to 5.0 kN and the permanent elongation for this energy absorber shall not exceed 1.2 meters. For the E6 compatible version, the maximum arresting force shall not exceed 7.0 kN and the permanent elongation shall not exceed 1.75 meters; and

5) Lastly, testing of a specimen that has been exposed to both water and a low temperature is carried out. Initially, the specimen is immersed in water at 20° C., ±2° C., for a minimum of eight hours. The specimen may be allowed to drain for up to fifteen minutes and is then conditioned at −35° C., ±2° C., for a minimum of eight hours. Within five minutes after the completion of conditioning, the specimen is tested and the E4 compatible version shall limit the arresting force to 6.0 kN or less and the permanent elongation of this energy absorber shall not exceed 1.2 meters. For the E6 compatible version, the maximum arresting force shall not exceed 8.0 kN and the permanent elongation does not exceed 1.75 meters.

To meet the dynamic performance standards of the American National Standards Institute (ANSI) for an energy absorber, the energy absorber must not exceed a permanent elongation of 42 inches and the arresting force shall not exceed 900 pounds. The contents of each of the Z259 Canadian Standard and the Z359 American Standard are incorporated in their entirety by reference herein.

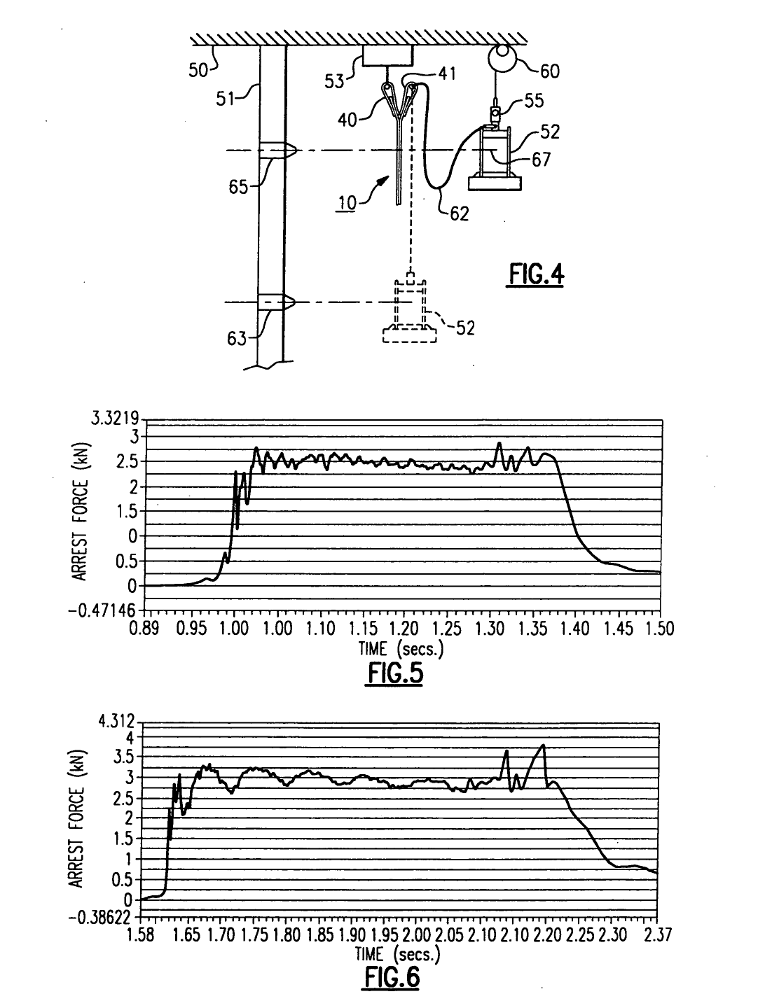

A number of test specimens were constructed which contain the double two-ply webbing arrangement with the two webbings being woven together using both exterior and interior bindings that were configured as described above. The specimens were tested in the above noted test stand to determine the maximum arresting force and permanent elongation of the absorber reached during testing. As graphically depicted in FIGS. 5 and 6, one E4 and one E6 compatible configuration was identified which consistently met or exceeded all the dynamic drop test requirements set out in the published Canadian National Standard. The E4 compatible specimen webbing according to this configuration had a length of 609 millimeters, while the E6 compatible version has a length of 959 millimeters. Both the E4 and E6 compatible version according to this configuration had a width of 44 millimeters. (The face ply and back ply of both webbings contained fifty-two ends of 1,300 denier two-ply high tenacity yarn). The wefts of the E4 webbing were fabricated of 1,300 denier high tenacity polyester, while the wefts of the E6 webbing were fabricated of 1000 denier para-aramid yarn, specifically DuPont Kevlar or Teijin Twaron according to this embodiment. Each webbing further included twenty-five ends of exterior tear elements and twenty-five ends of interior tear elements fabricated of 1,000 or 1300 denier high tenacity polyester yarns.

FIGS. 5 and 6 are graphical representations showing typical test results based on the above noted E4 and E6 compatible configurations, respectively, as subjected to dynaniic performance tests under the ambient portion (see paragraph 1 noted hereinabove) of the above noted Canadian Standard. In each of these representations, arrest force (as measured in kN) is plotted against time (as measured in seconds). The E4 specimen, as depicted in FIG. 5, had a permanent elongation of 0.984 meters while having a maximum arresting force of 2.89 kN. The E6 specimen, as depicted in FIG. 6, had a permanent elongation of 1.66 meters while having a maximum arresting force of 3.82 kN. Each of the foregoing tests was performed under the ambient and dry drop test conditions specified in paragraph 1) of the Canadian standard, as noted hereinabove. As noted from the above results, each of the test specimens clearly met the safety requirements promulgated for the E4 and E6 standards, respectively. The above results for the E4 design also effectively met the safety requirements under the American Standard. It should be noted that the above test results are typical, wherein each of the designs effectively and minimally met each of dynamic test conditions specified in paragraphs 1)-5) of the above referred to Canadian Standard.

Minimally, the binder yarns can be coated with a material for improving the binder's yarn on yarn abrasion resistance as well as protecting the binder against moisture. One such coating material that greatly enhanced the absorber's performance is a siloxane-based material that forms a durable polymeric network over the surface of the binders which is marketed by Performance Fibers, Inc. under the trademark SEAGARD. In a further embodiment, the performance of the energy absorber is further enhanced by also coating the webbing wefts with the above noted siloxane-based material.

While this invention has been particularly shown and described with reference to the preferred embodiment in the drawings, it will be understood by one skilled in the art that various changes in its details may be effected therein without departing from the teachings of the invention. For example, the herein described energy absorber has been described in terms of various test requirement standards. However, it should be readily apparent that the herein described energy absorbers can easily be modified to withstand other suitable load conditions, as needed (e.g., additional height drop in excess of an E4 or E6 standard with equivalent results in terms of permanent elongation and arresting force).

What is claimed is:

1. An energy absorber for use as part of a personal fall arresting system that includes:
upper and lower two-ply webbings, each having a face ply and a back ply extending along the length of the webbing, said webbings mounted one over the other with the back ply of the upper webbing being adjacent to the face ply of the lower webbing;
exterior tear elements running back and forth sinusoidally between attachment points on the face ply of the upper webbing and the back ply of the lower webbing;
interior tear elements running back and forth sinusoidally between attachment points on the back ply of the upper webbing and the face ply of the lower webbing wherein each tear yarn is looped around wefts that pass laterally through warp ends contained in said face plys and said back plys of the upper and lower webbings, and in which the tear elements are fabricated of a material that will rupture before the face weft and back weft of the upper and lower webbings when the absorber is placed under load, wherein the face weft and back weft are made from one of a polyester and a para-aramid yarn.

2. The energy absorber of claim 1, wherein the attachment points are evenly distributed along the width of selected ends of each ply.

3. The energy absorber of claim 1, wherein said coating is a siloxane-based material that forms a polymeric network over the surface of the tear elements.

4. The energy absorber of claim 1, wherein each tear yarn is fabricated of a continuous high tenacity polyester that is coated with a material for protecting the yarn against yarn on yarn abrasion at extreme temperatures either while dry or after exposure to moisture.

5. The energy absorber of claim 4, wherein a lock stitch is included along the knitted edges of the webbings.

6. An energy absorber for use as a component part of a personal fall arresting system that includes:
a two-ply upper webbing having face ply and back ply each containing uniformly spaced wefts that pass laterally through warps located in the plys of said upper webbing;
a two-ply lower webbing having face ply and back ply each containing uniformly spaced wefts that pass laterally through warps located in the plys of the said lower webbing;
said webbing being mounted one over the other with the back ply of the upper webbing located adjacent to and in alignment with the face ply of the lower webbing with the wefts in the two back ply being spaced about midway between the wefts in the two face plys;
a number of continuous exterior tear yarns, each of which runs back and forth over the wefts contained in the face ply of the upper webbing and adjacent wefts contained in the back ply of the lower webbing to establish a sinusoidal-shaped exterior binder;
a number of continuous interior tear yarns, each of which runs back and forth over the wefts contained in the back ply of the upper webbing and adjacent wefts contained in the face ply of the lower webbing to establish a sinusoidal-shaped interior binder wherein each of said uniformly spaced wefts are made from a material that has a tensile strength greater than that of the exterior tear yarns and the interior tear yarns, said wefts being made from one of a polyester and a para-aramid yarn.

7. The energy absorber of claim 6, wherein each tear yarn is fabricated of a continuous high tenacity polyester that is coated with a material for protecting the yarn against yarn on yarn abrasion at extreme temperatures either while dry or after exposure to moisture.

8. The energy absorber of claim 7, wherein said yarn coating is a siloxane-based material that forms a durable polymeric coating over the surface of the binders.

9. The energy absorber of claim 6, wherein each ply contains about fifty-two face ends and about fifty-two back ends.

10. The energy absorber of claim 9, wherein each ply further contains about twenty-five exterior tear yarns and about twenty-five interior tear yarns.

11. The energy absorber of claim 6, wherein said warps are fabricated from 1,300 denier two-ply high tenacity polyester yarns, said wefts are at least one of 1,300 denier single ply high tenacity polyester and 1000 denier para-aramid yarn, and said tear yarns are fabricated of at least one of 1,000 denier and 1300 denier high tenacity polyester yarns.

12. The energy absorber of claim 6, wherein said wefts are coated with a material for protecting the wefts against yarn on yarn abrasion at extreme temperatures either while dry or after exposure to moisture.

13. The energy absorber of claim 6, wherein said para-aramid yarn is Kevlar.

14. The energy absorber of claim 6, wherein said para-aramid yarn is Twaron.
